(19) United States
(12) Patent Application Publication
(10) Pub. No.: US 2017/0013075 A1
(43) Pub. Date: Jan. 12, 2017

(54) ELECTRONIC DEVICE AND NOTE REMINDER METHOD

(71) Applicant: HON HAI PRECISION INDUSTRY CO., LTD., New Taipei (TW)

(72) Inventor: CHIA-LI YAO, New Taipei (TW)

(21) Appl. No.: 14/836,350

(22) Filed: Aug. 26, 2015

(30) Foreign Application Priority Data
Jul. 7, 2015 (TW) 104122084

(51) Int. Cl. H04L 29/08; G06F 9/44; G06F 17/24; G06F 3/0482; G06F 3/0484

(52) U.S. Cl. CPC H04L 67/26; G06F 3/0482; G06F 3/04842; G06F 17/243; G06F 9/4446; H04L 67/18

(57) ABSTRACT

In a note reminder method, the note includes a reminder event and personal information of a person associated with the reminder event, a current location of the electronic device is obtained. When a distance between the current location and a location of the person associated with a note is determined to be less than or equal to a predefined distance, the note reminder is executed.

### CROSS-REFERENCE TO RELATED APPLICATIONS

This application claims priority to Taiwanese Patent Application No. 104122084 filed on Jul. 7, 2015, the contents of which are incorporated by reference herein.

### FIELD

The subject matter herein generally relates to note management, and more specifically relates to a method for executing a person-based note reminder.

### BACKGROUND

A note is a briefly written record that is used to remind somebody to do something at certain time. Generally, when arrival time of the note is recorded, the user is notified in a predefined way.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing a note reminder system.

FIG. 2 is a block diagram of one embodiment of function modules of the note reminder system in FIG. 1.

FIG. 3 is a flowchart of one embodiment of a method for executing a note reminder.

FIG. 4 is a flowchart of one embodiment of the block 33 in FIG. 3.

FIG. 5 is a flowchart of an alternative embodiment of the block 33 in FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

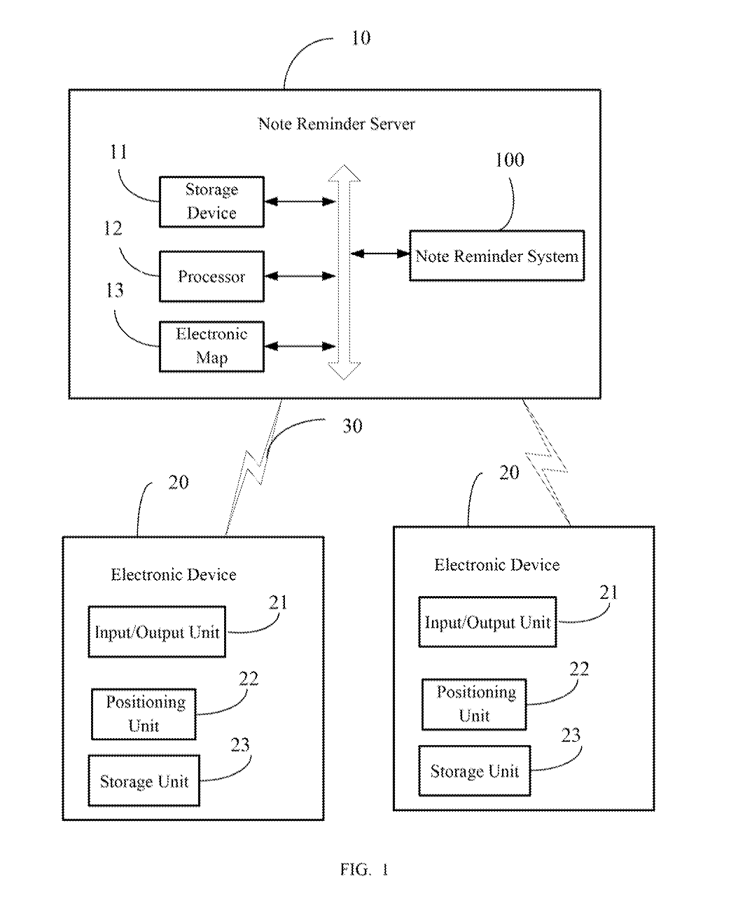

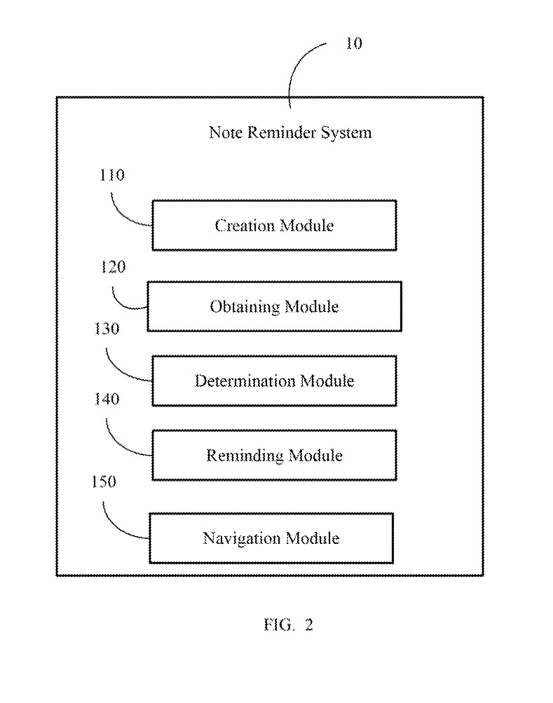

FIG. 1 is a block diagram of one embodiment of a hardware environment for executing a person-based note reminder system (hereinafter “note reminder system”). The note reminder system 100 is installed and run in an apparatus, for example a note reminder server 10. The note reminder server 10 can communicate with a number of electronic devices 20 through a network 30. The network 30 can be, but is not limited to, an internet, a wireless network or a Local Area Network (LAN). In the embodiment, the note reminder system 100 is installed and run in the note reminder server 10. In an alternative embodiment, the note reminder system 100 is installed and run in the electronic devices 20. In still an alternative embodiment, several modules of the note reminder system 100 are installed and run in the electronic device 20, such as a creating module 110 and a reminder module 140 shown in FIG. 2) can be installed and run in the electronic device 20, and other remaining modules are installed and run in the note reminder server 10.

In at least one embodiment as shown in FIG. 1, the note reminder server 10 includes, but is not limited to, a storage device 11, at least one processor 12, and an electronic map 13. FIG. 1 illustrates only one example of the note reminder server 10; others can include more or fewer components than illustrated, or have a different configuration of the various components in other embodiments.

In at least one embodiment, the storage device 11 can include various types of non-transitory computer-readable storage mediums. For example, the storage device 11 can be an internal storage system, such as a flash memory, a Random Access Memory (RAM) for temporary storage of information, and/or a Read-Only Memory (ROM) for permanent storage of information. The storage device 11 can also be an external storage system, such as a hard disk, a storage card, or a data storage medium. The at least one processor 12 can be a Central Processing Unit (CPU), a microprocessor, or other data processor chip that performs functions of the note reminder system 100 in the note reminder server 10. The electronic map 13 can store geographic locations of an area and the detail information on roads of the area. The area can be, but is not limited, a country, a city, or a district. The electronic map 13 can be a two-dimensional map or a three-dimensional map.

In at least one embodiment as shown in FIG. 1, the electronic device 20 can be a tablet computer, a notebook computer, a smart phone, a personal digital assistant (PDA), or other suitable electronic device. The electronic device 20 includes, but is not limited to, an input/output unit 21, a positioning unit 22, and a storage unit 23. The input/output unit 21 can be used by a user to input commands and display information to the user. In the embodiment, the input/output unit 21 is a touch screen. In other embodiments, the input/output unit 21 can include an input device such as a mouse, a keyboard, or a touch panel, and an output device such as a display screen. The positioning unit 22 can provide a current location of the electronic device 20. In the embodiment, the positioning unit 22 is a Global Positioning System (GPS) device. The storage unit 23 can include various types of non-transitory computer-readable storage mediums. For example, the storage unit 23 can be an internal storage system, such as a flash memory, a Random Access Memory (RAM) for temporary storage of information, and/or a Read-Only Memory (ROM) for permanent storage of information. The storage unit 23 can also be an external storage system, such as a hard disk, a storage card, or a data storage medium. The storage unit 23 can store reminders created by users. FIG. 1 illustrates only one example of the electronic device 20; others can include more or fewer components than illustrated, or have a different configuration of the various components in other embodiments.

The note reminder system 100 can determine whether a distance between a current location of a user of the electronic device 20 who created a note and a current location of a person associated with the note is less than or equal to a predefined distance. And when the distance between the current location of the user and the current location of the person associated with the note is less than or equal to the predefined distance, the note is shown as a reminder for the user.

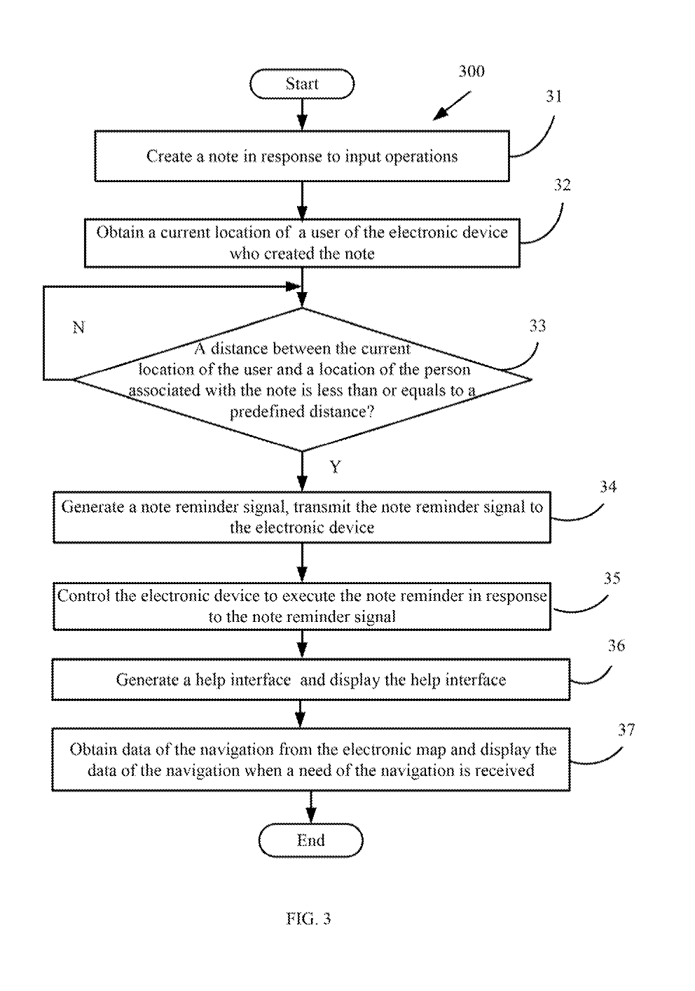

FIG. 2 is a block diagram of one embodiment of the function modules of the note reminder system 100. In at least one embodiment, the note reminder system 10 can include the creation module 110, an obtaining module 120, a determination module 130, the reminding module 140, and a navigation module 150. The function modules 110-150 can include computerized codes in the form of one or more programs, which are stored in the storage device 11. The processor 12 executes the computerized codes to provide functions of the function modules 110-150. A detailed description of the functions of the modules 100-150 is given below in reference to FIGS. 3-5.

FIG. 3 illustrates a method for executing a note reminder. The example method 300 is provided by way of example, as there are a variety of ways to carry out the method. The method 300 described below can be carried out using the configurations illustrated in FIGS. 1-3, for example, and various elements of these figures are referenced in explaining example method 300. Each block shown in FIG. 3 represents one or more processes, methods or subroutines, carried out in the exemplary method 300. Furthermore, the illustrated order of blocks is by example only and the order of blocks can change according to the present disclosure. The exemplary method 300 can begin at block 301. Depending on the embodiment, additional blocks can be added, others removed, and the ordering of the blocks can be changed.

At block 31, the creation module creates a note in response to input operations. In the embodiment, the note includes a reminder event and personal information of a person associated with the reminder event. In the embodiment, the personal information of a person can be an identification code or an IP address assigned by the note reminder system 100.

It is to be understood, the user who creates the note and the person associated with the note are registered members of the note reminder system 100. Once a member fills register information on the note reminder system 100, the note reminder system 100 can assign an identification code or an IP address to the member. The identification code or an IP address is used to recognize the member. Hereinafter, user or person is registered member of the note reminder system 100.

In the embodiment, the created note includes one or more elements from text information, picture information, audio information, and video information. In at least one embodiment, in response to a note creation operation, a person list is provided and displayed on the input/output unit 21; a user applies a selection operation on the person list to select a person, and an input operation on the input/output unit 21 to input content of the reminder event associated with the selected person. In one embodiment, the person list includes all members registered on the note reminder system 100. In an alternative embodiment, the person list includes members who have a social relationship with the user who creates the note, such as friends, colleges, or family members. The person list is provided from an address book of mobile phone or a social network of the user. The creation module 110 creates the note based on the selection operation and the input operation.

In other embodiments, the creation module 110 provides an input box in response to a note creation operation. The note creation operation can be an operation to select a menu item for creating notes. The user applies input operations in the input box to input personal information of a person and content of the reminder event associated with the person. The creation module 110 creates the note based on the input operations. The creation module 110 further stores the created notes in the storage device 11. In the embodiment, the user clicks a particular item of a menu to initiate the note creation operation.

At block 32, the obtaining module obtains a current location of the user of the electronic device, who created the note, provide by the positioning unit.

At block 33, the determination module determines whether a distance between the current location of the user obtained by the obtaining module and a location of the person associated with the note is less than or equal to a predefined distance; if yes, the process goes to block 34; otherwise, the process goes back to block 33.

At block 34, the reminding module generates a note reminder signal, transmits the note reminder signal to the electronic device.

At block 35, the reminding module further controls the electronic device to execute the note reminder in response to the signal.

In at least one embodiment, the reminding module 140 controls to display content of the note on the input/output unit 21 or sounds out the content of the note. In other embodiments, the reminding module 140 further controls the electronic device 1 to vibrate or produce a particular sound.

In the embodiment, the reminding module 140 obtains the contact information of the person associated with the note, such as mobile phone number, and connects a call between the user and the person associated with the note. For example, the reminding module 140 generates a call connect interface to ask the user of the electronic device whether a call connect between the user and the person associated with the note is needed and displays the call connect interface on the input/output device. When the user determines the call connect is needed, the reminding module 140 connects the call between the user and the person associated with the note.

In an alternative embodiment, the reminding module 140 obtains current location of the person associated with the note from the electronic map 13, marks the current location of the person in the electronic map, and transmits the marked current location of the person to the electronic device 20 of the user via a predefined way, for example, as a map picture or electronic map containing the marked current location.

In another embodiment, the reminding module 140 further re-determines the location relationship between the user and the person associated with the note in a predefine time interval such as 1 minute, transmits the re-determined location relationship to the electronic device 20, and controls the input/output unit 21 to display the re-determined location relationship. The re-determined location relationship can be, but is not limited, away from or close to.

At block 36, the navigation module generates a help interface to ask the user of the electronic device whether navigation from the current location of the user to the location of the person associated with the note is needed and displays the help interface on the input/output device.

At block 37, when a need of the navigation from the current location of the user to the location of the person associated with the note is received; the navigation module obtains data of the navigation from the electronic map 13 and displays the data of the navigation.

The data of the navigation includes, but is not limited to, a distance, a path, vehicles, time cost, and money cost from the current location of the user to the location of the person associated with the note.

In one embodiment, the help interface includes two operable items including a “yes” and a “no”. When the item of “yes” is selected, the request for providing the navigation is generated and the navigation is provided. When the item of “no” is selected, the navigation from the current location to the location associated with the note will not be provided.

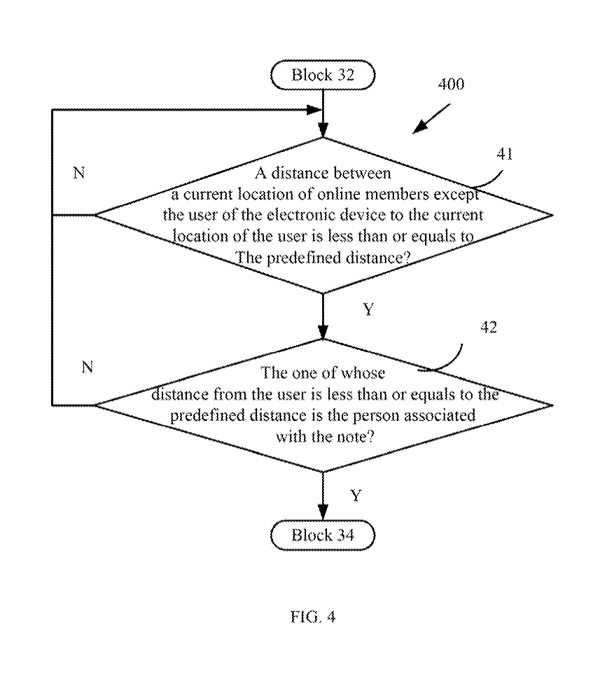

FIG. 4 illustrates a detail description of one embodiment of the block 33. The example method 400 is provided by way of example, as there are a variety of ways to carry out the method. The method 400 described below can be carried out using the configurations illustrated in FIGS. 1-2, for example, and various elements of these figures are referenced in explaining example method 400. Each block shown in FIG. 4 represents one or more processes, methods or subroutines, carried out in the exemplary method 400. Furthermore, the illustrated order of blocks is by example only and the order of blocks can change according to the present disclosure. The exemplary method 400 can begin at block 41. Depending on the embodiment, additional blocks can be added, others removed, and the ordering of the blocks can be changed.

At block 41, the determination module determines whether a distance between a current location of any other online members except the user of the electronic device to the current location of the user is less than or equal to the predefined distance; if yes, the process goes to block 42; otherwise, the process goes back to block 32.

The online member is a user who logs into the note reminder system 100. In one embodiment, the obtaining module 120 obtains current locations of the other online members; the determining module 130 compares the current locations of the other online members and the current location of a user of the electronic device to determine whether a distance between the current location of the user who created the note and the current location of any other online members is less than or equal to a predefined distance. The predefined distance can be determined according to need.

In alternative embodiment, the determining module 130 recognizes other online member except the user of the electronic device who locates in a predefined area via wireless network technology, such as BLUETOOTH. A distance from the predefined area to the current location of the user is less than or equal to the predefined distance. For example, a wireless network is set up; a distance from the cover area of the wireless network to the current distance of the user, who creates the note, equals or less than the predefined distance, the determining module 130 obtains identification information of electronic devices, such as Media Access Control (MAC) address of the BLUETOOTH of an electronic device. The electronic device is used by the other online member who is located in the area of the wireless network. In the embodiment, the note reminder system 100 stores a relationship between the identification information of electronic devices and MAC addresses of the electronic devices.

At block 42, the determining module determines whether the one whose distance from the user is less than or equal to the predefined distance is the person associated with the note; if yes, the process goes to block 34; if no, the process goes back to block 41.

In the embodiment, the determining module 130 compares whether personal information of the one whose distance from the user is less than or equal to the predefined distance is same as the personal information of the person associated with the note. When the personal information the one whose distance from the user is less than or equal to the predefined distance is same as the personal information of the person associated with the note, the determining module 130 determines he or she is the person associated with the note.

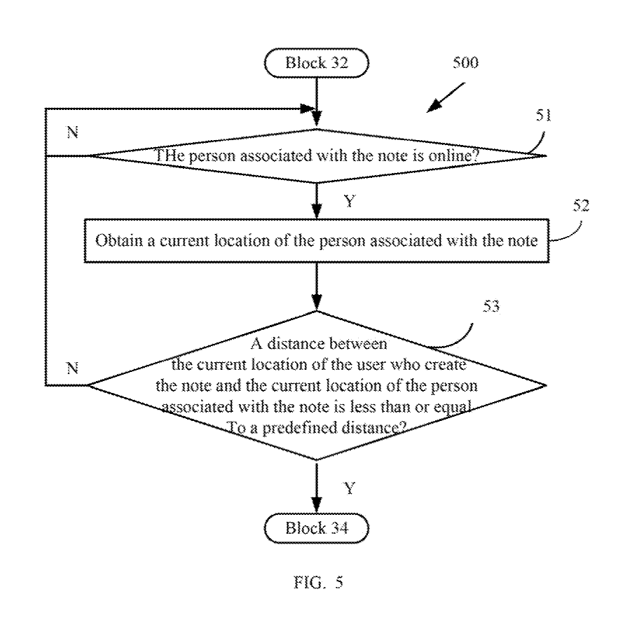

FIG. 5 illustrates a detail description of an alternative embodiment of the block 33. The example method 500 is provided by way of example, as there are a variety of ways to carry out the method. The method 500 described below can be carried out using the configurations illustrated in FIGS. 1-2, for example, and various elements of these figures are referenced in explaining example method 500. Each block shown in FIG. 5 represents one or more processes, methods or subroutines, carried out in the exemplary method 500. Furthermore, the illustrated order of blocks is by example only and the order of blocks can change according to the present disclosure. The exemplary method 500 can begin at block 51. Depending on the embodiment, additional blocks can be added, others removed, and the ordering of the blocks can be changed.

At block 51, the determining module determines whether the person associated with the note is online. If yes, the process goes to block 52; if no, the process goes back to block 51.

At block 52, the obtaining module obtains a current location of the person associated with the note.

At block 53, the determining module determines a distance between the current location of the user who created the note and the current location of the person associated with the note is less than or equal to a predefined distance. If yes, the process goes to block 34; if no, the process goes back to the block 51.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method of a note reminder executable by at least one processor of a note reminder server, the note comprising a reminder event and personal information of a person associated with the reminder event, the method comprising:
obtaining a current location of an electronic device, which communicates with the note reminder server;
determining whether a distance between the current location and a location of the person associated with the note is less than or equal to a predefined distance;
generating a note reminder signal when the distance between the current location and the location of the person associated with the note is less than or equal to a predefined distance;
transmitting the note reminder signal to the electronic device; and
controlling the electronic device to execute the note reminder in response to the signal.

2. The method according to claim 1, further comprising creating the note associated with a location; and storing the note in the note reminder server.

3. The method according to claim 2, wherein the note associated with a person is created by:
providing a person list;
receiving a selection operation on the person list to select a person and an input operation for inputting content of the reminder event associated with the selected person; and
creating the note based on the selection operation and the input operation.

4. The method according to claim 2, wherein the note associated with a person is created by:
providing an input box;
receiving input operations in the input box to input personal information of a person and content of the reminder event associated with the person; and
creating the note based on the input operations.

5. The method according to claim 1, further comprising:
generating a help interface to ask whether navigation from the current location to the location of the person associated with the note is needed;
displaying the generated help interface;
obtaining data of the navigation from an electronic map when receiving a need of the navigation from the current location to the location of the person associated with the note; and
displaying the data of the navigation.

6. The method according to claim 1, wherein the “determining whether a distance between the current location and a location of the person associated with the note is less than or equal to a predefined distance” comprises:
determining whether a distance between a current location of any other online members except the user of the electronic device to the current location of the electronic device is less than or equal to the predefined distance;
comparing personal information of online members whose distances from the electronic device are less than or equal to the predefined distance with the personal information of the person associated with the note; and
determining any online member whose distance from the electronic device is less than or equal to the predefined distance and further whose personal information match the personal information of the person associated with the note to be the person associated with the note.

7. The method according to claim 1, wherein the “determining whether a distance between the current location and a location of the person associated with the note is less than or equal to a predefined distance” comprises:
obtaining a current location of the person associated with the note; and
determining whether a distance between the current location of the electronic device and the current location of the person associated with the note is less than or equal to a predefined distance.

8. The method according to claim 1, further comprising:
obtaining current location of the person associated with the note from an electronic map of the note reminder server;
marking the current location of the person in the electronic map; and
transmitting the marked current location of the person to the electronic device via a predefined way.

9. The method according to claim 8, further comprising:
re-determining a location relationship between the user and the person associated with the note in a predefine time interval;
transmitting the re-determined location relationship to the electronic device; and
displaying the re-determined location relationship on the electronic device, wherein the re-determined location relationship comprises far away or is close to.

10. An electronic device comprising:
a processor; and
a storage device that stores a note and one or more programs, the note comprising a reminder event and a location associated with the event, the programs which, when executed by the processor, cause the processor to:
obtain a current location of an electronic device;
determine whether a distance between the current location and a location of the person associated with the note is less than or equal to a predefined distance;
generate a note reminder signal when the distance between the current location and the location of the person associated with the note is less than or equal to a predefined distance; and
control the electronic device to execute the note reminder in response to the signal.

11. The electronic device according to claim 10, wherein the “determining whether a distance between the current location and a location of the person associated with the note is less than or equal to a predefined distance” comprises:
determining whether a distance between a current location of any other online members except the user of the electronic device to the current location of the electronic device is less than or equal to the predefined distance;
comparing personal information of online members whose distances from the electronic device are less than or equal to the predefined distance with the personal information of the person associated with the note; and
determining any online member whose distance from the electronic device is less than or equal to the predefined distance and further whose personal information match the personal information of the person associated with the note to be the person associated with the note.

12. The electronic device according to claim 10, wherein the “determining whether a distance between the current location and a location of the person associated with the note is less than or equal to a predefined distance” comprises:
obtaining a current location of the person associated with the note; and
determining whether a distance between the current location of the electronic device and the current location of the person associated with the note is less than or equal to a predefined distance.

13. The electronic device according to claim 10, further comprising:
obtaining current location of the person associated with the note from an electronic map of the note reminder server;
marking the current location of the person in the electronic map; and
transmitting the marked current location of the person to the electronic device via a predefined way.

14. The electronic device according to claim 13, further comprising:
re-determining a location relationship between the user and the person associated with the note in a predefine time interval;
transmitting the re-determined location relationship to the electronic device; and
displaying the re-determined location relationship on the electronic device, wherein the re-determined location relationship comprises far away or is close to.

15. A non-transitory storage medium having stored thereon instructions that, when executed by a processor of an electronic device, causes the processor to perform a method for a not reminding, wherein the method comprises:
obtaining a current location of an electronic device;
determining whether a distance between the current location and a location of the person associated with the note is less than or equal to a predefined distance;
generating a note reminder signal when the distance between the current location and the location of the person associated with the note is less than or equal to a predefined distance;
transmitting the note reminder signal to the electronic device; and
controlling the electronic device to execute the note reminder in response to the signal.

16. The non-transitory storage medium according to claim 15, wherein the “determining whether a distance between the current location and a location of the person associated with the note is less than or equal to a predefined distance” comprises:
determining whether a distance between a current location of any other online members except the user of the electronic device to the current location of the electronic device is less than or equal to the predefined distance;
comparing personal information of online members whose distances from the electronic device are less than or equal to the predefined distance with the personal information of the person associated with the note; and
determining any online member whose distance from the electronic device is less than or equal to the predefined distance and further whose personal information match the personal information of the person associated with the note to be the person associated with the note.

17. The non-transitory storage medium according to claim 15, wherein the “determining whether a distance between the current location and a location of the person associated with the note is less than or equal to a predefined distance” comprises:
obtaining a current location of the person associated with the note; and
determining whether a distance between the current location of the electronic device and the current location of the person associated with the note is less than or equal to a predefined distance.

18. The non-transitory storage medium according to claim 15, further comprising:
obtaining current location of the person associated with the note from an electronic map of the note reminder server;
marking the current location of the person in the electronic map; and
transmitting the marked current location of the person to the electronic device via a predefined way.

19. The non-transitory storage medium according to claim 18, further comprising:
re-determining a location relationship between the user and the person associated with the note in a predefine time interval;
transmitting the re-determined location relationship to the electronic device; and
displaying the re-determined location relationship on the electronic device, wherein the re-determined location relationship comprises far away or is close to.

20. The non-transitory storage medium according to claim 15, further comprising:
generating a help interface to ask whether navigation from the current location to the location of the person associated with the note is needed;
displaying the generated help interface;
obtaining data of the navigation from an electronic map when receiving a need of the navigation from the current location to the location of the person associated with the note; and
displaying the data of the navigation.
